(19) United States
(12) Patent Application Publication
(10) Pub. No.: US 2012/0120125 A1
(43) Pub. Date: May 17, 2012

(54) LCD APPARATUS AND METHOD FOR COMPENSATING TEMPERATURE

(75) Inventors: Shin-woo CHOI, Suwon-si (KR); Kyung-hwan LEE, Suwon-si (KR); Tae-hun HA, Suwon-si (KR)

(73) Assignee: SAMSUNG ELECTRONICS CO., LTD., Suwon-si (KR)

(21) Appl. No.: 13/298,577

(22) Filed: Nov. 17, 2011

(30) Foreign Application Priority Data
Nov. 17, 2010 (KR) 10-2010-0114621

(51) Int. Cl. G09G 5/10; G09G 3/36; G09G 5/00

(52) U.S. Cl. 345/690; 345/204; 345/87

(57) ABSTRACT

An LCD apparatus and a method for compensating an input image based on temperature are provided. The LCD apparatus receives an external temperature of the LCD apparatus and compensates the input image based on the received external temperature and a measured internal temperature. Accordingly, a user may enjoy an image with optimum quality which is suitable for a current temperature.

### CROSS-REFERENCE TO RELATED APPLICATIONS

This application claims priority from Korean Patent Application No. 10-2010-0114621, filed in the Korean Intellectual Property Office on Nov. 17, 2010, the disclosure of which is incorporated herein by reference.

### BACKGROUND

1. Field

Aspects of the exemplary embodiments relate to a Liquid Crystal Display (LCD) apparatus and a method for compensating an image based on temperature, and more particularly, to an LCD apparatus which compensates a quality of an image according to temperature and a method for compensating temperature thereof.

2. Description of the Related Art

The recent trend of design of a display apparatus includes making the display apparatus thinner. In addition, with the development of technologies regarding Light Emitting Diodes (LEDs), there have been corresponding advancements in LED-related display technology and design. Particularly, as an LED is used in a backlight of a display apparatus, it has become possible to make display apparatuses thinner than ever before.

One advancement in realizing a thinner display apparatus involves using an edge-type LED backlight unit which is disposed on or at the edge of a display apparatus. This design is now widely used.

However, if the edge-type backlight is used, the temperature may increase near the edges of the LED display, while it may decrease toward the center of the LED. If the temperature of an LED drops, the response speed of the LED also decreases, making it difficult to provide a high-quality image. In particular, a 3D image requires a fast response time as the desired frequency for outputting an image is higher.

As a 3D image displays a left eye image and a right eye image alternately, cross-talk phenomenon may occur if the response time of an LED slows down. Therefore, a fast response time is required to represent a 3D image with high quality.

However, as noted above, the response time of an LED changes according to temperature, which may in turn deteriorate image quality and cause cross-talk.

Nevertheless, users wish to enjoy a high-quality image regardless of a change in temperature when he or she uses a display apparatus. Accordingly, a method for providing a display apparatus which maintains a high-quality image without being affected by temperature is required.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

An aspect of an exemplary embodiment provides an LCD apparatus which displays an input image, wherein the LCD apparatus may include: an internal temperature sensor which measures an internal temperature of the LCD apparatus; and a control unit which receives an external temperature of the LCD apparatus and compensates the input image based on the received external temperature and the measured internal temperature.

The apparatus may further include: a storage unit which stores a plurality of lookup tables having image compensation values corresponding to internal and external temperatures, wherein the control unit compensates the input image based on the received external temperature and the measured internal temperature by applying a lookup table corresponding to the received external temperature and the measured internal temperature from among the plurality of lookup tables.

The lookup table may include at least one of a brightness compensation value, a gamma compensation value, a white balance compensation value and a contrast compensation value.

The external temperature may be input by a user.

The apparatus may further include: an external temperature sensor which measures the external temperature of the LCD apparatus, wherein the control unit receives the external temperature measured from the external temperature sensor.

The external temperature sensor may be mounted on an external portion of the LCD apparatus.

The external temperature sensor may be mounted on a remote controller, and the control unit may receive the measured external temperature value via a remote control signal from the remote controller.

The internal temperature sensor may include a plurality of temperature sensors measuring temperatures at a plurality of areas of the LCD module, and the control unit may compensate the image based on respective internal temperatures measured at each of the plurality of areas and the received external temperature.

Another aspect according to an exemplary embodiment includes a method for compensating an input image displayed on an LCD apparatus, wherein the method may include: measuring an internal temperature of the LCD apparatus; receiving an external temperature of the LCD apparatus; and compensating the input image according to the received external temperature of the LCD apparatus and the measured internal temperature of the LCD apparatus.

The LCD apparatus may store a plurality of lookup tables having image compensation values corresponding to internal and external temperatures, wherein the compensating comprises adjusting an input image based on the received external temperature and the measured internal temperature by applying a lookup table corresponding to the received external temperature and the measured internal temperature from among the plurality of lookup tables.

The lookup table includes at least one of a brightness compensation value, a gamma compensation value, a white balance compensation value and a contrast compensation value.

The receiving of the external temperature comprises receiving the external temperature from a user.

The receiving of the external temperature comprises measuring the external temperature of the LCD apparatus with an external temperature sensor and receiving the measured external temperature from the external temperature sensor.

The external temperature sensor may be mounted on a remote controller, and the measuring of the external temperature may include measuring the external temperature with the external temperature sensor mounted on the remote controller, and the receiving of the external temperature may further include receiving the measured external temperature via a remote control signal from the remote controller.

The internal temperature sensor may include a plurality of temperature sensors measuring temperatures at a plurality of areas of the LCD apparatus, and the compensating of the input image may include adjusting an input image based on the received external temperature and respective internal temperatures measured by each of the plurality of temperature sensors.

The input image may be compensated in each of the plurality of areas of the LCD apparatus.

The applying of the lookup table may include extracting a lookup table, from among the plurality of lookup tables, based on the received external temperature and the measured internal temperature.

### BRIEF DESCRIPTION OF THE DRAWINGS

The above and/or other aspects of the present disclosure will be more apparent from the following description of the exemplary embodiments, with reference to the accompanying drawings, in which:

FIG. 1 is a block diagram illustrating configuration of an LCD TV according to an exemplary embodiment;

FIG. 2 is a flowchart to explain a method for compensating temperature of an LCD TV according to an exemplary embodiment;

FIG. 3 is a view illustrating a case where an external temperature sensor is mounted on a bezel of an LCD TV according to an exemplary embodiment;

FIG. 4 is a view illustrating a case where an external temperature sensor is mounted on a remote controller according to an exemplary embodiment;

FIG. 5 is a view illustrating a case where an external temperature is input by a user according to an exemplary embodiment;

FIGS. 6A and 6B are views illustrating a brightness lookup table for each temperature according to an exemplary embodiment; and

FIG. 7 is a view illustrating a case where an LCD module is divided into nine areas and includes nine internal temperature sensors according to an exemplary embodiment.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without the specifically defined matters. Also, well-known functions or constructions are not described in detail as they would obscure the application with unnecessary detail.

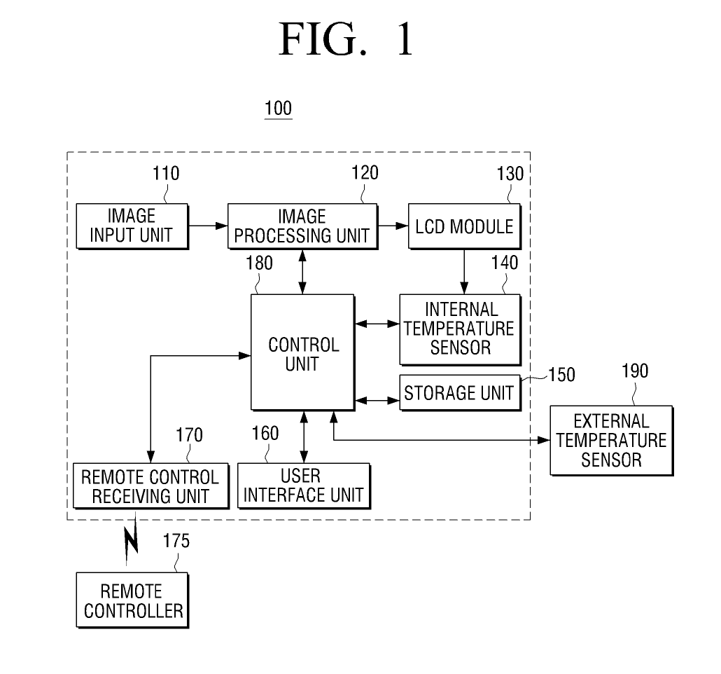

FIG. 1 is a block diagram illustrating configuration of an LCD TV 100 according to an exemplary embodiment. As illustrated in FIG. 1, the LCD TV 100 comprises an image input unit 110, an image processing unit 120, an LCD module 130, an internal temperature sensor 140, a storage unit 150, a user interface unit 160, a remote control receiving unit 170, a control unit 180, and an external temperature sensor 190.

The image input unit 110 receives an image signal from an external source. Specifically, the image input unit 110 may be a tuner for receiving a broadcast signal or an A/V interface for receiving wired broadcast, an analog image signal or a digital image signal.

The image processing unit 120 performs signal processing on an input image signal. Specifically, the image processing unit 120 performs signal processing such as scaling and decoding on an input image signal.

The LCD module 130 displays an image signal processed by the image processing unit 120. The LCD module 130 includes a liquid crystal panel and various optical sheets. In addition, the LCD module 130 includes a backlight. Herein, the backlight may be an edge-type backlight. The edge-type backlight represents a backlight which provides backlight by irradiating light from a side of an LCD. However, other types of backlights may also be applied.

The internal temperature sensor 140 measures internal temperature of the LCD apparatus 100. The internal temperature sensor 140 may measure temperature of other parts of the LCD apparatus 100. For example, the internal temperature sensor 140 may be mounted on the back of the LCD module 130 and measure temperature of the back of the LCD module 130. In addition, the temperature sensor 140 transmits information regarding the internal temperature which is information regarding measured temperature of the LCD module 130 to the control unit 180.

A temperature sensor is divided into contact-type and non-contact-type. The contact-type measures temperature by contacting an object to be measured and includes most of sensors such as (platinum) a resistance temperature sensor, thermistor, thermocouple, and bimetal, and non-contact-type includes a radiation thermometer, and a light high thermometer. As such, the temperature sensor 140 may be embodied by various temperature sensors.

In addition, the internal temperature sensor 140 may include a plurality of temperature sensors measuring temperature of a plurality of areas of the LCD module 130. For example, the internal temperature sensor 140 may include a total of nine temperature sensors to divide the LCD module 130 into nine areas and measure temperature of the nine areas, respectively.

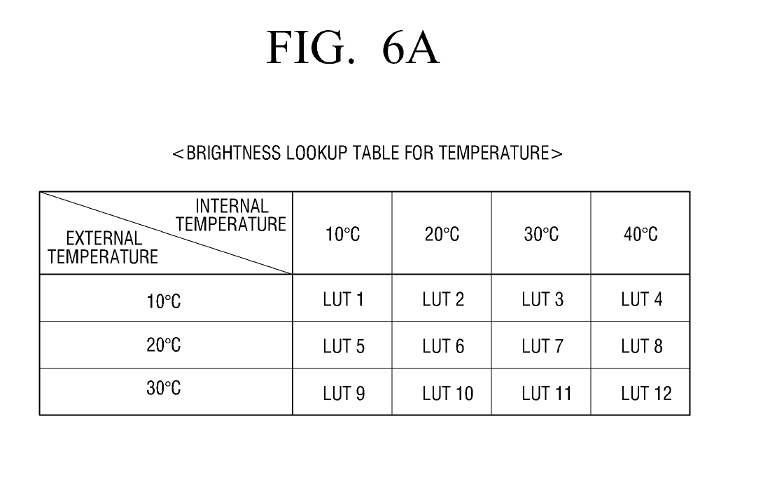

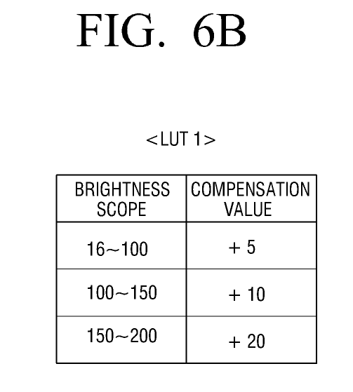

The storage unit 150 stores various kinds of software to drive the LCD TV 100. In addition, the storage unit 150 stores a plurality of lookup tables in which image quality compensation values according to external temperature and internal temperature of the LCD TV 100 are recorded. Herein, the lookup tables record image quality compensation values of an image according to various external and internal temperatures. Specifically, the lookup tables may include at least one of a brightness compensation value for internal and external temperatures, a gamma compensation value, a white balance compensation value and a contrast compensation value. For example, temperature compensation data may be a Dynamic Capacitance Compensation table which is set for each temperature. The lookup tables record image quality compensation values for internal and external temperatures which are obtained through experiment. An example of the lookup tables will be explained in detail with reference to FIGS. 6A and 6B.

The storage unit 150 may be various storage media such as a non-volatile memory and a hard-disk.

The user interface unit 160 receives a command from a user. Specifically, the user interface unit 160 receives a command regarding a temperature compensation mode and an external temperature value from a user. Herein, the temperature compensation mode refers to a mode for receiving external temperature and includes an automatic mode and a manual mode. If the temperature compensation mode is a manual mode, the user interface unit 160 receives an external temperature vale from a user. If the temperature compensation mode is an automatic mode, the LCD TV 100 uses an external temperature value measured through the external temperature sensor 190.

The user interface unit 160 may be a button or a touch screen formed on the LCD TV 100.

The remote control receiving unit 170 receives a user command from a remote controller 175. In addition, the remote control receiving unit 170 transmits the input command to the control unit 180. In particular, the remote controller 175 may include the external temperature sensor 190. In this case, the remote controller 175 transmits a measured external temperature value to the remote control receiving unit 170 through a remote control signal. Subsequently, the remote control receiving unit 170 transmits the external temperature value received from the remote controller 175 to the control unit 180.

The external temperature sensor 190 measures external temperature of the LCD TV 100. Accordingly, the external temperature sensor 190 is mounted on the outside of the LCD TV 100. For example, the external temperature sensor 190 may be mounted on the stay, bezel, or cover of the LCD TV 100, or may be embodied as a separate module connected via cable or wirelessly. In addition, as described above, the external temperature sensor 190 may be mounted on or built in the remote controller 175.

The control unit 180 controls overall operation of the LCD TV 100. Specifically, the control unit 180 receives external temperature of the LCD TV 100 and compensates an image quality (i.e., compensates the image) according to the received external temperature and internal temperature.

Herein, compensation of an image quality according to temperature represents compensating an image quality value of an image (i.e., compensating the image) according to the internal and external temperatures of the LCD TV 100. Lower the temperature of an LCD is, slower its response time becomes. Accordingly, the control unit 180 performs a compensation so that lower the temperature of the LCD TV 100, faster its response time becomes. In this case, a compensation of image quality according to temperature may be performed on a timing control board (TCON board). That is, the timing control board generates a driving signal where the compensation of image quality is performed and applies the driving signal to the LCD. Herein, the control unit 180 may apply compensation to the driving signal by adjusting the strength or duty ratio of driving current or driving voltage.

As such, the control unit 180 applies compensation of image quality according to temperature when a driving signal is generated and thus, the LCD module may provide consistent image quality in various temperatures and maintain high response speed even in low temperature.

In addition, the control unit 180 extracts a lookup table corresponding to received external temperature and measured internal temperature from among a plurality of lookup tables stored in the storage unit 150. The control unit 180 performs the compensation of the quality of the image using the extracted lookup table.

The control unit 180 may receive an external temperature value in various ways. Specifically, the control unit 180 may receive an external temperature value input from a user through the user interface unit 160 or the remote controller 175.

In addition, the control unit 180 may receive an external temperature value measured from the external temperature sensor 190 through wired/wireless communication. In particular, if the external temperature sensor 190 is mounted on the remote controller 175, the control unit 180 receives an external temperature value through a remote control signal.

If a plurality of temperature sensors are included in the internal temperature sensor 140, the control unit 180 may apply a compensation of image quality with respect to an image corresponding to each of a plurality of areas according to received external temperature and the corresponding internal temperature. For example, if the internal temperature sensor 140 divides the LCD module 130 into a total of nine areas and includes nine temperature sensors to measure temperature of each of the nine areas, the control unit 180 extracts a lookup table for internal temperature with respect to each of the nine areas. Subsequently, the control unit 180 compensates a quality of the image corresponding to each of the nine areas using the corresponding lookup table, respectively.

Since the LCD TV 100 having the above configuration applies a compensation of image quality according to internal and external temperatures under the control of the control unit 180, optimal image quality may be provided even in various temperatures. Accordingly, the LCD TV 100 may maintain high response speed even if the temperature of the LCD TV 100 decreases. Therefore, cross-talk phenomenon may be reduced when the LCD TV 100 displays a 3D image.

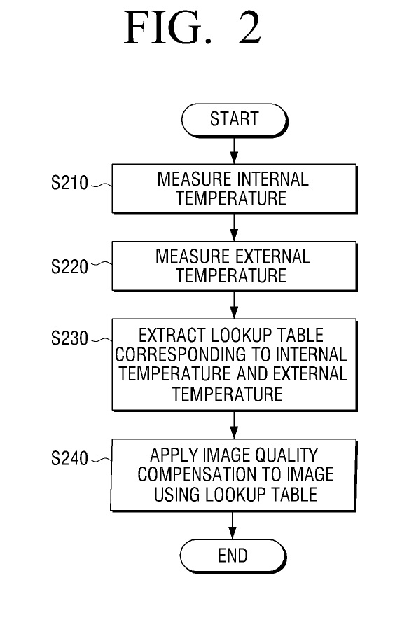

Hereinafter, a method for compensating temperature of the LCD TV 100 will be explained in detail with reference to FIG. 2. FIG. 2 is a flowchart to explain a method for compensating temperature of the LCD TV 100 according to an exemplary embodiment.

First of all, the LCD TV 100 measures internal temperature using the internal temperature sensor 140 (S210). In addition, the internal temperature sensor 140 may include a plurality of temperature sensors measuring temperature of a plurality of areas of the LCD module 130. In this case, the LCD TV 100 measures a plurality of internal temperatures of the LCD TV 100.

In addition, the LCD TV 100 receives external temperature (S220). The LCD TV 100 may receive an external temperature value measured by the external temperature sensor 190. The LCD TV 100 may also receive an external temperature input from a user.

The LCD TV 100 extracts a lookup table corresponding to received external temperature and measured internal temperature from among a plurality of lookup tables stored in the storage unit 150 (S230). In addition, the LCD TV 100 applies a compensation of image quality to an image using the extracted lookup table (S240).

In this case, if a plurality of temperature sensors are included in the internal temperature sensor 140, the LCD TV 100 may compensate image quality with respect to an image corresponding to each of a plurality of areas according to received external temperature and corresponding internal temperature. For example, if the internal temperature sensor 140 divides the LCD module 130 into a total of nine areas and includes nine temperature sensors to measure temperature of each of the nine areas, the LCD TV 100 extracts a lookup table for internal temperature with respect to each of the nine areas. Subsequently, the LCD TV 100 compensates image quality of an image corresponding to each of the nine areas using a lookup table corresponding to each of the nine areas, respectively.

Through the above process, the LCD TV 100 applies a compensation of image quality according to internal and external temperatures and thus, optimal image quality may be provided even in various temperatures. Accordingly, the LCD TV 100 may maintain high response speed even if the temperature of the LCD TV 100 decreases. Therefore, cross-talk phenomenon may be reduced when the LCD TV 100 displays a 3D image.

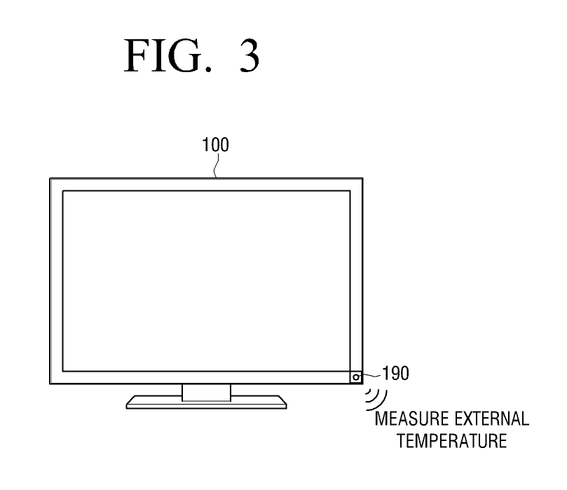

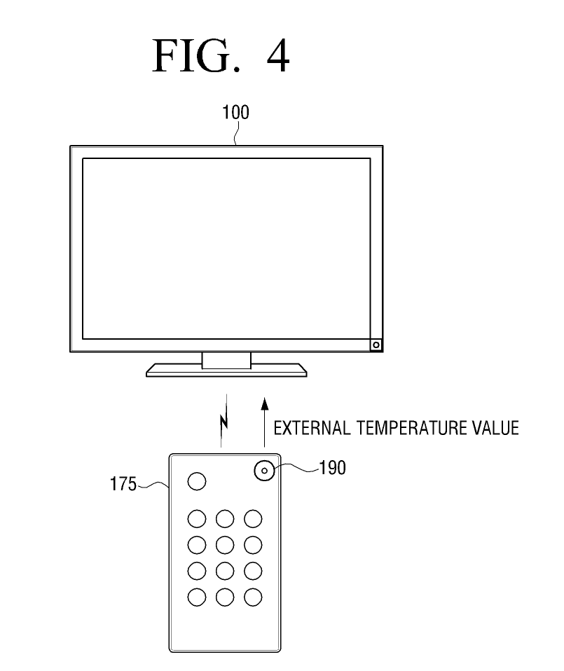

Hereinafter, various exemplary embodiments of the external temperature sensor 190 will be explained with reference to FIGS. 3 and 4. FIG. 3 is a view illustrating a case where an external temperature sensor is mounted on a bezel of the LCD TV 100 according to an exemplary embodiment.

As illustrated in FIG. 3, the external temperature sensor 190 may be mounted on a bezel of the LCD TV 100 and measure external temperature. In this case, the external temperature sensor 190 measures temperature of areas surrounding the LCD TV 100 as external temperature.

FIG. 4 is a view illustrating a case where the external temperature sensor 190 is mounted on the remote controller 175 according to an exemplary embodiment. Since the remote controller 175 is usually carried by a user, the external temperature sensor 190 measures temperature of areas surrounding users as external temperature. If the external temperature sensor 190 is mounted on the remote controller 175, the remote controller 175 transmits a measured external temperature value to the LCD TV 100 through a remote control signal.

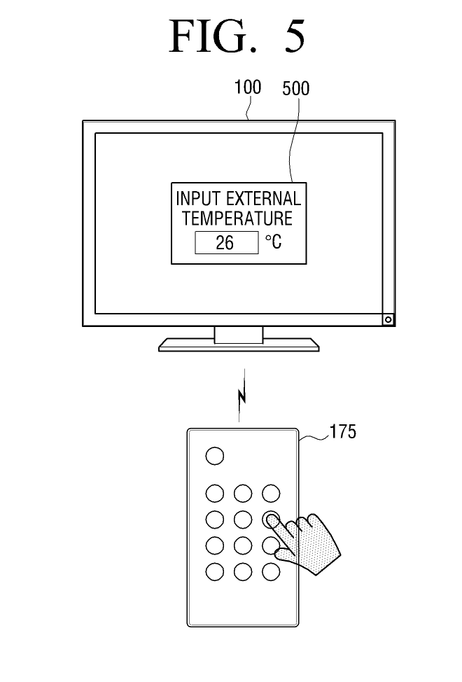

FIG. 5 is a view illustrating a case where an external temperature is input by a user according to an exemplary embodiment. As illustrated in FIG. 5, the LCD TV 100 may receive external temperature directly from a user through an external temperature input window 500. That is, if a user inputs an external temperature value using the remote controller 175, the LCD TV 100 displays the input external temperature value on the external temperature input window 500. Once the input is completed, the LCD TV 100 performs a compensation of an image quality using the input external temperature value.

Hereinafter, an example of a lookup table for each temperature will be explained with reference to FIGS. 6A and 6B. FIGS. 6A and 6B are views illustrating a brightness lookup table for each temperature according to an exemplary embodiment. FIGS. 6A and 6B illustrate a lookup table consisted of brightness compensation values from among image quality values.

As illustrated in FIG. 6A, various types of lookup tables are included according to internal temperature and external temperature. That is, twelve types of lookup tables, that is LUT 1 to LUT 12, are included according to internal temperature and external temperature.

Herein, each lookup table includes a compensation value according to brightness. Thus the extracting of the lookup table may also include extracting the appropriate lookup table first, and then extracting the value from the extracted look up table. Specifically, FIG. 6B illustrates an example of a specific brightness compensation value of LUT 1. According to FIG. 6B, there are three steps of brightness scope with a corresponding brightness compensation value, respectively, in LUT 1.

Accordingly, the LCD TV 100 may compensate image quality using such a lookup table according to internal temperature and external temperature.

Meanwhile, the LCD TV 100 becomes bigger, the LCD module 130 may have different temperature in each area. Accordingly, the LCD TV 100 may include a plurality of internal temperature sensors to measure internal temperature of various areas.

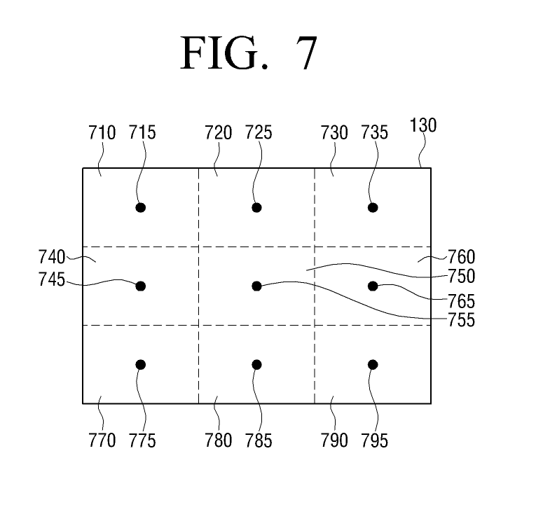

FIG. 7 is a view illustrating an example where the LCD module 130 is divided into nine areas and includes nine internal temperature sensors according to an exemplary embodiment. FIG. 7 illustrates a back of the LCD module 130.

As illustrated in FIG. 7, the LCD module 130 is divided into nine areas (710, 720, 730, 740, 750, 760, 770, 780, 790) and nine internal temperature sensors (715, 725, 735, 745, 755, 765, 775, 785, 795) are mounted for each area.

Accordingly, the LCD TV 100 measures temperature of each of the nine areas, compensates image quality of each of the nine areas, and displays the compensated image.

Therefore, the LCD TV 100 may prevent an imbalance in image quality due to inconsistent temperatures on a screen and thus, may display an image having more a consistent image quality on the screen.

In addition, the LCD TV 100 prevents a slow-down of response speed by applying a compensation of an image quality according to internal temperature and external temperature. Accordingly, the occurrence rate of cross-talk may be reduced when the LCD TV 100 displays a 3D image. Therefore, a user may enjoy a clear screen, with minimal cross-talk, while watching a 3D image.

In an exemplary embodiment, a display apparatus may be the LCD TV 100, but this is only an example of the present inventive concept. A display apparatus may be any type of LCD display apparatus. For example, an LCD apparatus could also be a 3D LCD TV, a general LCD TV, an LCD monitor or a notebook computer.

Although a few exemplary embodiments have been shown and described, it would be appreciated by those skilled in the art that changes may be made in these embodiments without departing from the principles and spirit of the present inventive concept.

What is claimed is:

1. An LCD apparatus which displays an input image, the LCD apparatus comprising:
an internal temperature sensor which measures an internal temperature of the LCD apparatus; and
a control unit which receives an external temperature of the LCD apparatus and compensates the input image based on the received external temperature and the measured internal temperature.

2. The apparatus as claimed in claim 1, further comprising:
a storage unit which stores a plurality of lookup tables having image quality compensation values corresponding to internal and external temperatures,
wherein the control unit compensates the input image based on the received external temperature and the measured internal temperature by applying a lookup table corresponding to the received external temperature and the measured internal temperature from among the plurality of lookup tables.

3. The apparatus as claimed in claim 2, wherein the lookup table includes at least one of a brightness compensation value, a gamma compensation value, a white balance compensation value and a contrast compensation value.

4. The apparatus as claimed in claim 1, wherein the external temperature is input by a user.

5. The apparatus as claimed in claim 1, further comprising:
an external temperature sensor which measures the external temperature of the LCD apparatus,
wherein the control unit receives the external temperature measured from the external temperature sensor.

6. The apparatus as claimed in claim 5, wherein the external temperature sensor is mounted on an external portion of the LCD apparatus.

7. The apparatus as claimed in claim 5, wherein the external temperature sensor is mounted on a remote controller, and
wherein the control unit receives the measured external temperature value via a remote control signal from the remote controller.

8. The apparatus as claimed in claim 1, wherein the internal temperature sensor includes a plurality of temperature sensors measuring temperatures at a plurality of areas of the LCD module, and
wherein the control unit compensates the image based on respective internal temperatures measured at each of the plurality of areas and the received external temperature.

9. A method for compensating an input image displayed on an LCD apparatus, the method comprising:
measuring an internal temperature of the LCD apparatus;
receiving an external temperature of the LCD apparatus; and
compensating the input image according to the received external temperature of the LCD apparatus and the measured internal temperature of the LCD apparatus.

10. The method as claimed in claim 9, wherein the LCD apparatus stores a plurality of lookup tables having image quality compensation values corresponding to internal and external temperatures,
wherein the compensating comprises adjusting a quality of the input image based on the received external temperature and the measured internal temperature by applying a lookup table corresponding to the received external temperature and the measured internal temperature from among the plurality of lookup tables.

11. The method as claimed in claim 10, wherein the lookup table includes at least one of a brightness compensation value, a gamma compensation value, a white balance compensation value and a contrast compensation value.

12. The method as claimed in claim 9, wherein the receiving of the external temperature comprises receiving the external temperature from a user.

13. The method as claimed in claim 9, wherein the receiving of the external temperature comprises measuring the external temperature of the LCD apparatus with an external temperature sensor and receiving the measured external temperature from the external temperature sensor.

14. The method as claimed in claim 13, wherein the external temperature sensor is mounted on an outside portion of the LCD apparatus.

15. The method as claimed in claim 13, wherein the external temperature sensor is mounted on a remote controller,
wherein the measuring of the external temperature comprises measuring the external temperature with the external temperature sensor mounted on the remote controller, and
wherein the receiving of the external temperature further comprises receiving the measured external temperature via a remote control signal from the remote controller.

16. The method as claimed in claim 9, wherein the internal temperature sensor includes a plurality of temperature sensors measuring temperatures at a plurality of areas of the LCD apparatus, and
wherein the compensating of the input image comprises adjusting a quality of the input image based on the received external temperature and respective internal temperatures measured by each of the plurality of temperature sensors.

17. The apparatus as claimed in claim 8, wherein the input image is compensated in each of the plurality of areas of the LCD apparatus.

18. The apparatus as claimed in claim 2, wherein the applying of the lookup table comprises extracting a lookup table, from among the plurality of lookup tables, based on the received external temperature and the measured internal temperature.

19. The apparatus as claimed in claim 18, wherein the applying of the lookup table further comprises extracting a value from the extracted lookup table based on the received external temperature and the measured internal temperature.
